(19) United States
(12) Patent Application Publication
(10) Pub. No.: US 2013/0284642 A1
(43) Pub. Date: Oct. 31, 2013

(54) METHOD OF BENEFICIATION OF PHOSPHATE

(71) Applicant: Adam Joseph Teague, Bendigo (AU)

(72) Inventor: Adam Joseph Teague, Bendigo (AU)

(73) Assignee: LEGEND INTERNATIONAL HOLDINGS, INC., Melbourne, Victoria (AU)

(21) Appl. No.: 13/881,413

(22) PCT Filed: May 31, 2011
(86) PCT No.: PCT/AU2011/000651

§ 371 Date: Jul. 12, 2013

Related U.S. Application Data
(60) Provisional application No. 61/406,229, filed on Oct. 25, 2010.

(51) Int. Cl. B03D 1/02

(52) U.S. Cl. CPC B03D 1/021
USPC 209/3.1

(57) ABSTRACT

A method of beneficiation of phosphate from a phosphate ore comprising: providing an aqueous slurry of phosphate ore in particulate form for conditioning comprising at least 60% by weight solids; conditioning the aqueous slurry by contacting the aqueous slurry with at least one conditioning agent selected from fatty acids and salts thereof and at least one hydrocarbon; diluting the conditioned slurry to provide a solids content of no more than 35% by weight; subjecting the diluted slurry to froth flotation comprising combining a pressurized stream of diluted slurry with air in a downcomer to form a foam comprising a dispersed air phase and introducing a downward stream of the foam into a floatation chamber comprising liquid below a surface of the liquid to form a floated froth; and collecting the floated froth to provide a solid enriched in phosphate.

### FIELD

The invention relates to the beneficiation of phosphate from phosphate ores by flotation in the presence of a flotation agent and in particular a method of beneficiation which allows recovery of phosphate fines conventionally removed in desliming.

### BACKGROUND

Flotation is one of the most effective techniques of beneficiation of phosphate. A pretreatment step of desliming, which removes fines, is regarded in the industry as a critical pretreatment to allowing the successful separation of phosphate from gangue material. The presence of fines of this type can have a significant negative effect on the effectiveness of the flotation process.

Examples of methods of desliming and their importance to effective recovery are discussed by Ahmed et al. “Optimisation of Desliming Prior to Phosphate Ore Upgrading by Flotation.” Physicochemical Problems of Mineral Processing, 41 (2007) 79-88. The use of screens or hydrocyclones to deslime the crushed ore dramatically improves the efficiency of flotation but in many cases the loss of phosphate fines is over 15% of the total phosphate. A Phase I technical report on “In Plant Testing of High-Efficiency Hydraulic Separators” contracted by Virginia Polytechnic Institute & State University (Virginia Tech) submission Date Dec. 2, 2004 discussed at pages 67-102 the “In-Plant Testing of Hydrofloat in the Phosphate Industry” and explains at page 75 that Beneficiation plants in Florida, one of the major areas for phosphate beneficiation in the USA plants typically wash and deslime ore matrix at 150 mesh so that finer than 150 mesh particles are considered tailings and pumped to settling ponds so that approximately 30% of phosphate contained in the original ore is lost to tailings ponds. Thus, while flotation is a very effective recovery method for beneficiation of phosphate there remains a need for a process which can accommodate a portion of fines normally discarded as tailings.

In Phosphate beneficiation operations around the world which use flotation as the principal mechanism to concentrate the phosphate bearing minerals, typically discard the “Ultrafine” phosphate bearing particles, where “Ultrafine” is defined as particles being smaller than 20 micron in diameter. It is standard practice in the phosphate industry to separate the ultrafines by scrubbing and hydrocycloning before the remainder of the raw rock feed is transferred to the flotation plant for concentration. This has been standard practice for a number of years because of the known poor flotation characteristics of the Ultrafines and because in the past it has been determined that the larger phosphate bearing particles float and concentrate more efficiently in the absence of Ultrafines. After the Ultrafines have been separated they are typically discarded and stored in large slimes ponds as tailings—effectively becoming lost revenue to the mining operation.

In standard phosphate flotation processes, mechanical flotation machines are the most widely used and are characterised by a mechanically driven impeller which agitates the slurry and disperses the incoming air into small bubbles.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY

We provide a method of beneficiation of phosphate from a phosphate ore comprising:
providing an aqueous slurry of phosphate ore in particulate form for conditioning comprising at least 60% by weight (preferably at least 65% and more preferably at least 70% by weight such as 60%-90%, 65%-85% and 70%-80%) solids;
conditioning the aqueous slurry by contacting the aqueous slurry with at least one agent selected from fatty acids and salts thereof and at least one hydrocarbon;
diluting the conditioned aqueous slurry to provide a solids content of no more than 35% by weight (preferably no more than 30% by weight such as 15% to 30% or 20% to 30%);
subjecting the diluted aqueous slurry to froth flotation comprising combining a pressurized stream of diluted aqueous slurry with air in a downcomer to form a foam comprising a dispersed air phase and introducing a downward stream of the foam into a flotation chamber comprising liquid below a surface of the liquid to form a floated froth; and
collecting the floated froth to provide a solid enriched in phosphate.

### DETAILED DESCRIPTION

Throughout the description and the claims of this specification the word “comprise” and variations of the word, such as “comprising” and “comprises” is not intended to exclude other additives, components, integers or steps.

Reference herein to particle size, particularly in relation to a slurry is a reference to particle size determined by wet sieving.

In contrast with the established methods of beneficiation of phosphate in which classification such as sieving or hydrocyclone classification is used to remove fines as tailings the method of the invention generally allows a high proportion of fines to be recovered without a separate tailings recovery process. Conventionally the inclusion of slimes or fine material in the beneficiation of phosphate has lead to unacceptable processing difficulties such as excessively high viscosity and/or poor flotation results.

The invention is particularly useful in beneficiation from ore or milled ore in which there are a significant proportion of fines such as particles of size no more than 20 microns. For example the method is particularly suited to use in beneficiation of phosphate from material in which at least 10% by weight (such as at least 15%, at least 20%, at least 25%, at least 30%, at least 35% or at least 40% by weight) of material is of size no more than 20 microns. Typically the proportion by weight of material of size less than 20 microns is no more than 80% by weight and preferably no more than 75% (such as no more than 70%, no more than 65% and no more than 60% by weight).

The method described herein generally is successfully in concentrating phosphate bearing ultrafines where they make up to 60% of the total mineral particles present in the rock feed, together with the remainder of the larger phosphate bearing particles, into a concentrate assaying 32% P₂O₅ or greater whilst recovering 80% or greater of the P₂O₅ in the original rock feed. The rock feed will typically contain at least 5% and more preferably at least 5% P₂O₅ and preferably at least 10% P₂O₅ to ensure a final concentrate grade of 32% P₂O₅ or greater. The rock feed may be relatively low grade and we have found that the process may be used in beneficiation of phosphate from low grade ore that would previously have been considered too low a grade to process.

The method of beneficiation of phosphate comprises a step of providing an aqueous slurry of phosphate ore in particulate form comprising at least 60% by weight (preferably at least 65% and more preferably at least 70% by weight. Examples of preferred ranges include ranges such as 65%-90%, 65%-85% and 70%-80%) solids;

In one set of preferred embodiments the aqueous slurry is formed by milling the ore, forming a dilute aqueous slurry of the milled ore suitable for hydrocyclone classification; classifying the dilute aqueous slurry of the milled ore to provide a size fraction in which at least 80% by weight pass a 150 micron sieve; and reducing the water content of the slurry to provide the aqueous slurry for conditioning. The solids content of the ore slurry for hydrocyclone classification is typically no more than 55% by weight. The oversized material, generally removed in the hydrocyclone underflow may be recycled for further milling to reduce the particle size before reclassification.

Milling is preferably carried out using a rod mill.

In order to provide solids content of least 60% by weight (preferably at least 65% and more preferably at least 70% by weight) the water content of the dilute ore slurry is reduced by filtration, preferably using a belt filter. We have found that conditioning of the aqueous slurry with high solids content is a significant advantage in achieving effective flotation of the phosphate particularly with high fines content. The method allows the conditioning step to be conducted in the presence of a significant proportion of fines. For example in one set of embodiments the aqueous slurry subject to conditioning comprises at least 20% (preferably at least 30% and more preferably at least 40%) by weight of particles of size less than 20 microns.

The method comprises a conditioning technique to ensure the ultrafines and the larger phosphate particles are rendered water repellent. Conditioning is followed by flotation using a flotation apparatus comprising at least one downcomer in place of the mechanical flotation apparatus conventionally used in phosphate flotation.

Conditioning the aqueous slurry is carried out by contacting the aqueous slurry with at least one agent selected from fatty acids and salts thereof and at least one hydrocarbon. The fatty acid and salts thereof may be selected from C12 to C36 fatty acids and may be saturated and/or unsaturated. Tall oil fatty acid and its salts are particularly useful. The fatty acid salts are generally preferred and in particular the potassium and sodium salts such as the potassium and sodium salts of tall oil fatty acid. It will be appreciated that where fatty acid is used, part or all of the fatty acid may be converted to a salt in situ at alkaline pH.

The dosing of fatty acid and/or salt may vary depending on the source of the ore and may be determined having regard to the disclosure herein without undue experimentation. The fatty acid and/or salt is used in an amount to provide effective flotation in the apparatus comprising a downcomer. Typically the dose is in the range of from 0.5 to 3 kg agent per tonne (based on fatty acid equivalent in the case of salts) of dry solid contained in the slurry.

The hydrocarbon may be a range of natural or synthetic hydrocarbons. Fuel oils, such as fuel oils No. 2, No 3, No. 4, No. 5, No 6 or mixtures thereof, may be used. In particular we have found petroleum diesel (typically containing C8 to C22 hydrocarbons) to be particularly useful. The dosing of hydrocarbon may vary depending on the type of hydrocarbon, the nature of the fatty acid and/or salt collection agent and the ore. Generally the dose will be similar to that of the collector agent such as 0.5 to 3 kg (based on fatty acid equivalent in the case of salts) per tonne of dry ore contained in the slurry.

The collector agent and hydrocarbon may be added to the aqueous slurry together or separately. They can be added neat or in the presence of diluents such as alkaline aqueous diluents if desired.

In cases where the content of Fe₂O₃ and Al₂O₃ is relatively high such as at least 5% by weight of the solids content of the slurry, it is preferred to also use a gum such as a vegetable gum and in particular a galactomannan gum such as guar gum. The proportion of gum may, for example, be in the weight range of from 1% to 30% by weight based on the weight of the collector agent (based on fatty acid equivalent in the case of salts). The gum may be added to the slurry at a dosage of 0.05 to 1.0 kg/t and is preferably agitated for a following addition. A pH adjusting agent such as Na₂CO₃ may be added at the milling stage or up to or including the conditioning tank. The pH adjusting agent may be added and mixed with the slurry in the conditioning tank, for example for 2 minutes and the fatty acid collector and diesel together or separately added and mixed with the slurry for a further period of, for example, 6 minutes. Where used the guar gum may then be added and mixed with the slurry for a period (for example 2 minutes). Typically when it is used the guar gum is mixed with the slurry after the phosphate particles have been made hydrophobic by the collector and hydrocarbon. The metal content of Fe₂O₃ and Al₂O₃ may be determined by an instream analyser (XRF) which may for example be located before milling so the need to use guar gum based on content of Fe₂O₃ and Al₂O₃ and variation in ore composition can be determined prior to conditioning.

Conditioning is typically conducted in the presence of a pH adjusting agent such as caustic soda or Na₂CO₃. The proportion of pH adjusting agent by dry weight of the aqueous slurry will depend on the nature of the ore but is typically sufficient to provide a pH of the aqueous slurry in the range of from 9.0 to 10.5 and preferably 9.0 to 10.0.

The method comprises a step of diluting the conditioned aqueous slurry to provide a solids content of no more than 35% by weight (preferably no more than 35% by weight such as 15% to 35%, 15-30%, 15-25% or 20-25%) of aqueous slurry. The diluted conditioned slurry is introduced to the one or more downcomers of the float cell and may be retained in a holding tank prior to the flotation step.

The types of flotation apparatus used heretofore in flotation of phosphates generally induce aeration by the action of the impeller in the slurry, via an external blower or combination of these methods. We have found that the combination of steps disclosed above allow phosphate fines to be effectively beneficiated by subjecting the diluted aqueous slurry to froth flotation in a step comprising combining a pressurized stream of diluted aqueous slurry with air in a downcomer to form a foam comprising a dispersed air phase and introducing a downward stream of the foam into a flotation chamber comprising liquid below a surface of the liquid to form a floated froth.

A range of flotation apparatus comprising a downcomer suitable for use in the method are known in the art for flotation of coal and metal values but have not to our knowledge been used in flotation of phosphate.

Examples of such apparatus are disclosed in U.S. Pat. No. 4,938,865, WO 2006/081611, WO 2007/065199 and WO 2009/026612. Examples of suitable froth flotation apparatus are known as the Jameson Cell and are commercially available from Xstrata Technology.

The flotation apparatus may have one or more downcomers and may be of type described in WO2007/065199. Following dilution of the aqueous slurry which has been conditioned the diluted slurry for beneficiation is introduced to the downcomer in the form of a jet of slurry from a nozzle and is mixed with air admitted via an air inlet. Turbulence created in the downcomer results in fine air bubbles being entrained in the slurry to form foam which flows into the flotation tank at a downcomer outlet below the liquid level in the tank.

As the fresh feed flow generally fluctuates, the amount of recycle may automatically be adjusted to maintain a constant head in the pump box and thus a constant feed. The added bonus with the Jameson Cell recycle mechanism is the improved grade and recovery since the feed material is passed through the downcomer a number of times. Typically about 40% of material gets two “chances” in the downcomer. Significant preferred aspects of the Jameson Cell operation are the recycle of the tailings and the addition of wash water in the form of a spray which is directed down onto the froth. The Jameson Cell performs best with a relatively constant flow, volume and pressure. To provide a constant flow of slurry to the downcomer, some of the tailings may be recycled back to feed sump. The wash water has the effect of removing some non-valuable gangue from the phosphate loaded air bubbles and improving the phosphate grade of the concentrate resulting from flotation.

The method involves the dilution of the slurry with water at different stages during the method steps. The aqueous slurry is diluted after conditioning, water is used to form the slurry for conditioning and in one embodiment water may be sprayed onto the froth formed by one or more downcomers in the flotation tank of a froth flotation apparatus. The water used in the method may be fresh water, recycled water or mixture. In one set of embodiments it is particularly preferred that the water used in the method has a concentration of no more than 10 mg/L combined Ca²⁺ and Mg²⁺ and preferably no more than 5 mg/L. Water used in beneficiation of phosphate is frequently sourced in remote locations and or is recycled to minimize usage and avoid the environmental impact of waste disposal. Consequently the level of calcium and magnesium salts it typically very significantly more than a combined concentration of 10 mg/L and typically more than 15 mg/L. In one set of embodiments the water is treated in an ion exchange unit to reduce the concentration of Ca²⁺ and Mg²⁺ ions in the water, for example by exchange with Na⁺ ions. The method preferably uses water that has been recycled and treated to reduce the concentration to no more than 10 mg/L combined Ca²⁺ and Mg²⁺ (more preferably no more than 5 mg/L and most preferably no more than 1 mg/L). We have found that the reduction in the combined concentration of calcium and magnesium significantly improves flotation performance following conditioning of the aqueous slurry according to the method.

The water may be recycled from the flotation process and preferably also from filtration prior to conditioning and the recycled water subject to deionization to reduce the combined magnesium ion and calcium ion content of the recycled water from more than 10 mg/L such as from more than 15 mg/L to no more than 10 mg/L and preferably to no more than 5 mg/L and most preferably to no more than 1 mg/L.

The concentrate froth from flotation is collected and the solids isolated by methods known in the art such as dewatering using a thickener, filtration, evaporation or a combination of such methods. In one embodiment the solids may be isolated from the froth by dewatering, for example by use of a commercially available thickener and then passing through a filter so that the water content in the concentrate is reduced to approximately 18-20% (80-82% solids) and finally the water level may be dried by evaporation (about 7-10% water) to provide a product which can be readily handled supplied for commercial use.

In one set of embodiments the invention utilises Rougher, Scavenger and Cleaner Flotation stages. These flotation operations preferably use essentially the same general method and flotation devices. The grade of the slurry which is used for each one and the sequence will however differ. The first pass through the Jameson Cell as described above may be referred to as a “Rougher” flotation. Once all the feed has been floated, the method may involve collection of the concentrate and tailing and Passing the tailings through a further Jameson Cell. This further flotation may be called “Scavenger” flotation because it is in effect “scavenging” further phosphate remaining in the rougher tailing that the rougher float did not collect. As a result of the scavenger flotation the scavenger concentrate and tailing may be collected. The scavenger tailing may be the final tailing which is disposed of to, for example, a tailings dam. Further scavenger flotation may be used if desired although we have found this is not generally necessary to obtain high yield.

The scavenger concentrate and the rougher concentrate may be combined together and used as the feed for the cleaner flotation. Accordingly the 3^{rd} and final pass through a flotation cell (preferably a Jameson Cell for a combined concentrate) may be in cleaner flotation. The cleaner stage preferably upgrades the concentrate grade to the final level of at least 32% P₂O₅. In a full scale plant set up the cleaner tailing may be recycled to the start of the scavenger flotation to “Scavenge” more phosphate. The same or different cells may be used for rougher, scavenger and cleaner flotation stages but generally in large scale production it is preferred to use distinct cells (preferably all Jameson type cells).

Accordingly in one embodiment there are at least 2 Jameson Cells set up for continuous operation including rougher and scavenger and more preferably at least 3 Jameson Cells including rougher, scavenger and cleaner cells.

### BRIEF DESCRIPTION OF THE DRAWINGS

An embodiment of the method will be described with reference to the attached drawings.

In the drawings:

FIG. 1 is a schematic cross section of a flotation cell comprising a plurality of downcomers which is used in one set embodiments

FIG. 2 is a schematic cross section of a downcomer of FIG. 1 in operation.

FIG. 3 shows a flow diagram of the method.

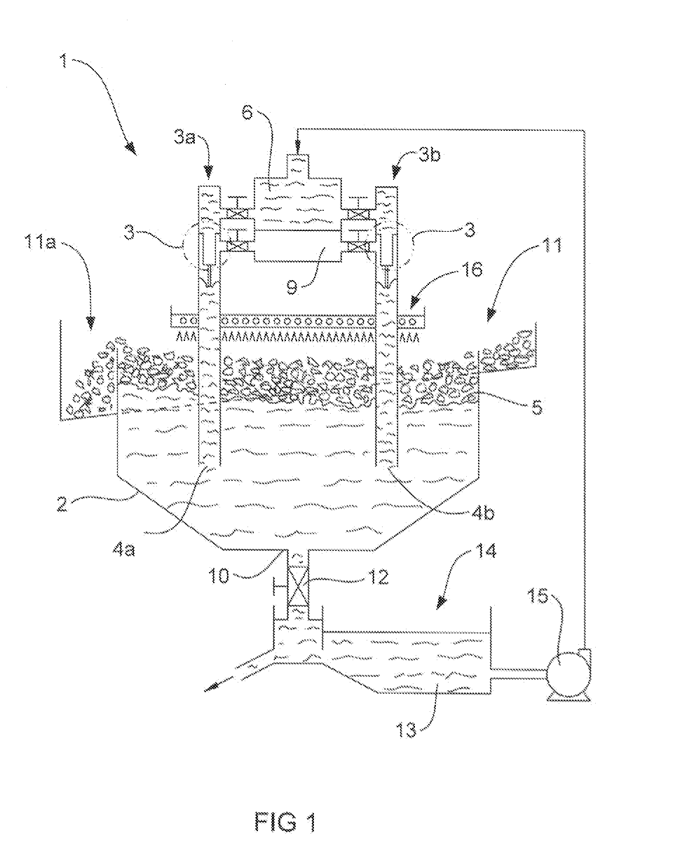

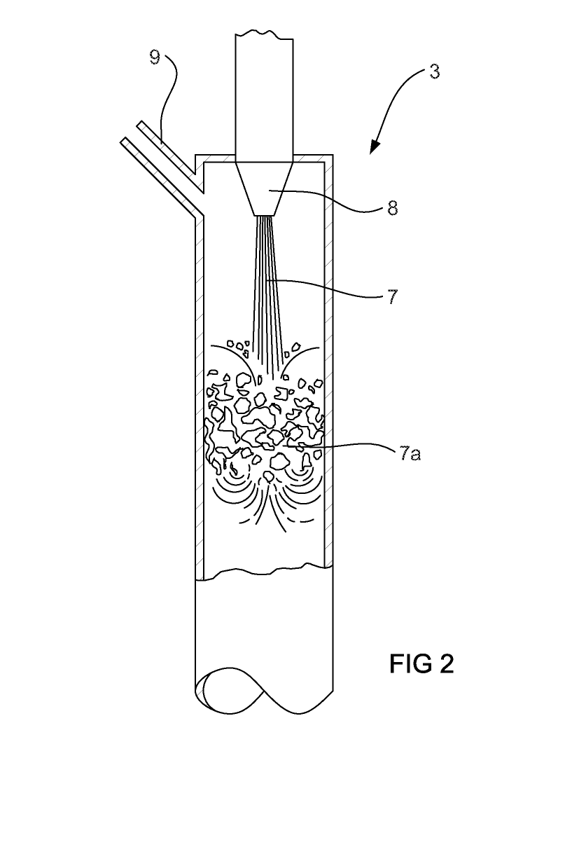

Referring to FIG. 1, there is shown a froth flotation cell (1) comprising a flotation tank (2) which receives froth produced in a plurality of downcomers (3a, 3b) in the form of vertically oriented columns having outlets (4a, 4b) within the tank (2) which in operation are generally below the liquid level (5). The downcomers (3a, 3b) each form foam from the diluted aqueous slurry in an inlet holding tank (6). As shown in FIG. 2 each of the downcomers (3) produce foam by delivering a jet (7) of the diluted aqueous slurry downward from a nozzle (8). The downcomer (3) is provided with an air inlet (9). The jet (7) creates a venturi and a turbulent region (7a) in the downcomer which facilitates mixing of air with the diluted slurry so as to entrain fine air bubbles within the slurry and produce dense foam. The foam passes downward within the downcomer (referring to FIG. 1) to the downcomer outlet (4a, 4b) and into the tank (4) below the liquid level (5) to produce froth. The average air bubble size is typically 200 to 400 micron compared with about 1000 micron for mechanical flotation machines. The total surface area of 1 mm³ of air may be about 20 mm².

The air bubbles entrained in the froth and adherent particles, which are enriched in the conditioned phosphate, move upward while tailings enriched in gangue, such as clay particles, settle downward toward the bottom (10) of the flotation tank (2). The upwardly moving froth rises to the collected in a weir (11) and moves over the weir into a launder (11a) where it is recovered as enriched phosphate. Tailings which settle toward the bottom (10) of the flotation tank (2) may be removed via outlet valve (12).

A portion of the tailings slurry is collected in a sump (13) and recycled with addition of fresh diluted conditioned aqueous slurry (14). The fresh diluted conditioned aqueous slurry may be added to the sump to mix with recycled material. This may be used to ensure constant flow of feed to the downcomers (3a, 3b) via a pump (15) for recycling slurry from tailings sump (13) to the inlet holding tank (6). In a preferred set of embodiments a spray of water is directed onto the froth from a wash water conduit (16).

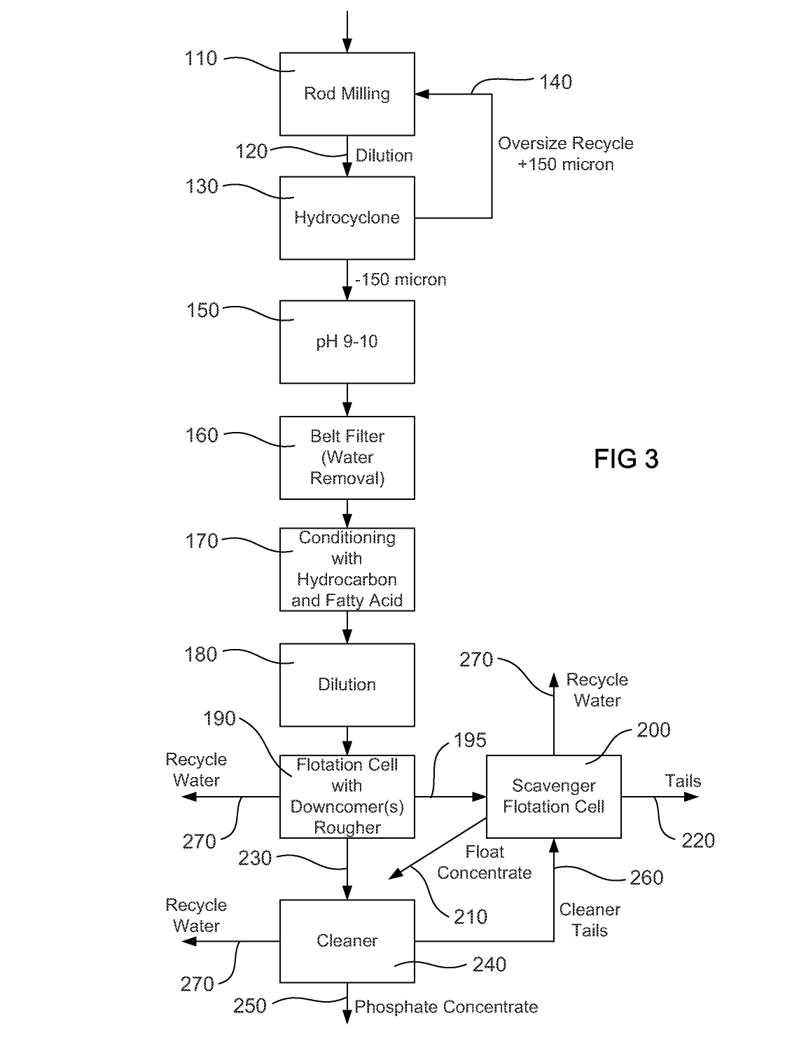

Referring to FIG. 3, an embodiment of the process is shown in the flow diagram. Prior to flotation, the ore particles (100) are ground in a rod mill (110) to between 80% and 100% finer than 150 micron in diameter. The milled ore is diluted (120) to have a solids content of no more than 55% by weight and classified to remove the oversized material using a hydrocyclone (130). The −150 fraction (140) is transferred to a vacuum belt filter for dewatering (160). The +150 micron fraction (150) gets recycled to the rod mill (110) for regrinding. Sodium carbonate (Na₂CO₃) is added at 0.8 kg/t during grinding or reagent conditioning and ensures the pH of the slurry is maintained between 9.0 and 10.0 (160). This pH has a dual effect of reducing the floatability of the iron and aluminium bearing contaminant minerals in the slurry and also helps to neutralise Ca²⁺ and Mg²⁺ ions in the process water that may otherwise activate and promote the flotation of non-valuable silica from the mineral matrix. The belt filter (150) reduces the moisture content of the −150 micron fraction from approximately 50% to a minimum of 30% (70% solids). The −150 micron fraction at 70% solids or greater is then transferred to the flotation conditioning tank (170) where diesel and a tall oil fatty acid with a carbon chain of C18 are both added to the slurry at a dosage of 1.3 kg/t. The tall oil fatty acid is the reagent which provides hydrophobicity to the phosphate bearing mineral particles so that on contact with air bubbles there is an increased probability that they will attach and float. The diesel is added as an extender for the tall oil fatty acid. The tall oil fatty acid and diesel can be added as separate “neat” solutions or they can be added together as a soap mixture made up of 5 wt % tall oil fatty acid, 5 wt % diesel, 0.25 wt % caustic soda and 89.5 wt % water. The slurry is stirred in the tank at between 400 and 800 rpm for 10 minutes. After the first eight minutes of agitation, if the Fe₂O₃ and Al₂O₃ content of the feed are greater than or equal to 4% respectively (such as greater than 5% respectively) then guar gum is added to the slurry at a dosage of 0.25 kg/t and is agitated for a further two minutes. The guar gum has the effect of reducing the floatability of the iron and aluminium bearing minerals which would otherwise lower the value of the phosphate concentrate and its ability to be made into phosphoric acid. The conditioned slurry is then diluted to 25% solids with process water and then flows to the first of three Jameson Cell flotation machines which are set up as a flotation rougher (190), scavenger (200) and cleaner (210) configuration. The rougher cell (190) and preferably also the scavenger cell (200), comprise at least one and preferably a plurality of downcomers as described with reference to FIGS. 1 and 2. No additional reagents are added to either of the flotation cells and no further adjustments are made to the solids density of the slurry. The rougher flotation cell generates a concentrate and tailing stream and the tailing stream (195) flows to the scavenger flotation cell (200) for further recovery of any remaining phosphate values (210). The resultant tailing from the scavenger cell is the final tailing (220) from the whole process and may be thickened and pumped to a tailings dam for disposal. The concentrate (210) from the scavenger cell (200) is combined with the concentrate (230) from the rougher cell (190) and this stream is fed to the cleaner flotation cell (240). The cleaner cell upgrades the P₂O₅ content of the concentrate from approximately 26-28% to at least 32% and this is the final phosphate concentrate product (250) from the process. The tailing (260) from the cleaner cell is recycled back to the head of the scavenger cell (200) where it joins together with the rougher tailings for re-treatment. The used process water and fresh process water are collected into a holding tank, which then flows to an ion exchange unit (8) that reduces the concentration of Ca²⁺ and Mg²⁺ ions in the water by exchange with Na⁺ ions. The process described preferably uses process water with a concentration of less than or equal to 10 mg/L combined Ca²⁺ and Mg²⁺.

The invention will now be described with reference to the following examples. It is to be understood that the examples are provided by way of illustration of the invention and that they are in no way limiting to the scope of the invention.

### EXAMPLES

### Examples 1-4

Examples 1-4 are from the operation of a laboratory pilot scale semi-continuous process. A JC150 Jameson Cell was used for flotation of approximately 30-60 kg bulk samples taken from the field. After silica removal by dry tumbling and screening at 25 mm, the −25mm feed was batch ground in a laboratory rod mill at 63% solids to a targeted particle size of 80% passing 150 micron. The mill discharge was filtered to approximately 75% solids and conditioned in a stirred tank at between 400 and 800 rpm for 10 minutes. At time zero, 0.8 kg/t of sodium carbonate was added to the slurry and agitated for two minutes followed by the addition of 1.3 kg/t of fatty acid soap (consisting of 5 wt % tall oil fatty acid, 5 wt % diesel, 0.25 wt % caustic soda and 89.5 wt % water) which was agitated for a further six minutes. At that point, 0.25 kg/t of food grade guar gum was added as a 1 wt % solution to the slurry and the mixture was agitated for a further two minutes, bringing the total conditioning time up to ten minutes. The conditioned slurry was diluted with softened tap water to 20% solids and was then pumped to the JC150 Jameson Cell feed box at approximately 0.35 m³/h for flotation. Continuous rougher, scavenger and cleaner flotation was carried out separately and the concentrates and tailings were sampled and assayed for P₂O₅, Fe₂O₃, Al₂O₃, CaO by ICP and MgO and SiO₂ by XRF. For cleaner flotation the concentrates from the roughing and scavenging stage were mixed together and retreated in the Jameson Cell without any further dilution or reagent addition.

In Example 1, after silica removal at 25 mm, the mill feed consisted of 50 kg at 20.9% P₂O₅, 5.63% Fe₂O₃, 5.77% Al₂O₃ and 29.8% SiO₂ with 46.7% of the mass being Ultrafines (−20 μm). The mill feed was ground to 96.8% −150 μm, and then it was conditioned at 75% solids for two minutes with 37.7 gram of sodium carbonate, followed by six minutes with 2355 ml of fatty acid soap, followed by two minutes with 1177 ml of 1 wt % guar gum solution. The conditioned slurry was then transferred to a dilution tank where softened water was added to lower the pulp density to approximately 20% solids, followed by flotation in the Jameson Cell. The results in Table 1 show that 96.4% P₂O₅ was recovered to a concentrate grading 36.4% P₂O₅, whilst the Fe₂O₃ and Al₂O₃ grades were reduced to 2.19% and 0.86% respectively.

TABLE 1
Example 1 Flotation Results

| | P₂O₅ % | Fe₂O₃ % | Al₂O₃ % | SiO₂ % |
|---|---|---|---|---|
| Feed | 20.90 | 5.63 | 5.77 | 29.80 |
| Rougher | 34.90 | 2.84 | 1.51 | 8.30 |
| Concentrate | | | | |
| Final Concentrate | 36.40 | 2.19 | 0.86 | 6.00 |
| Final Tail | 7.22 | 8.09 | 10.50 | 53.00 |
| P₂O₅ Recovery % | 96.40 | | | |

In Example 2 using the same laboratory pilot scale apparatus, after silica removal the mill feed consisted of 22 kg at a grade of 23.8% P₂O₅, 3.55% Fe₂O₃, 3.65% Al₂O₃ and 30.9% SiO₂ with 37% of the mass being Ultrafines (−20 μm). The mill feed was ground to 94.8% −150 μm, then it was conditioned at 75% solids with 20.78 gram of sodium carbonate and 1299 ml of fatty acid soap using the same procedure as for example 1, except no guar gum was added because the Fe₂O₃ and Al₂O₃ content was already below 4% each. The conditioned slurry was diluted to 20% solids then transferred to the Jameson Cell for flotation. The results in Table 2 show that 97.4% P₂O₅ was recovered to a final concentrate grading 36.7% P₂O₅ while the Fe₂O₃ and Al₂O₃ grades were reduced to 2.13% and 0.66% respectively.

TABLE 2
Example 2 Flotation Results

| | P₂O₅ % | Fe₂O₃ % | Al₂O₃ % | SiO₂ % |
|---|---|---|---|---|
| Feed | 23.80 | 3.55 | 3.65 | 30.90 |
| Rougher | 33.20 | 4.67 | 0.92 | 12.20 |
| Concentrate | | | | |
| Final Concentrate | 36.70 | 2.13 | 0.66 | 4.30 |
| Final Tail | 1.72 | 3.09 | 10.0 | 76.50 |
| P₂O₅ Recovery % | 97.40 | | | |

For Example 3, the same laboratory pilot scale apparatus and reagent addition sequence as described in the preceding example 1 was used, including 0.25 kg/t guar gum for Fe₂O₃ and Al₂O₃ depression. After silica removal at 25 mm, the mill feed consisted of 64 kg at a grade of 16.2% P₂O₅, 5.35% Fe₂O₃, 7.01% Al₂O₃ and 38.4% SiO₂ with 41.3% of the mass being Ultrafines (−20 μm). The mill feed was ground to 93.7% -150 μm then it was conditioned at 75% solids with 51.2 gram of sodium carbonate, 3125 ml of fatty acid soap and 1600 ml of 1 wt % guar gum solution followed by dilution of the slurry to 20% solids and flotation in the Jameson Cell. The results in Table 3 show that 94.1% P₂O₅ was recovered to a concentrate grading 33% P₂O₅ while the Fe₂O₃ and Al₂O₃ grades were reduced to 3.33% and 1.14% respectively.

TABLE 3
Example 3 Flotation Results

| | P₂O₅ % | Fe₂O₃ % | Al₂O₃ % | SiO₂ % |
|---|---|---|---|---|
| Feed | 16.20 | 5.35 | 7.01 | 38.4 |
| Rougher | 30.60 | 3.84 | 1.93 | 9.00 |
| Concentrate | | | | |
| Final Concentrate | 33.00 | 3.33 | 1.14 | 6.30 |
| Final Tail | 1.77 | 5.67 | 12.30 | 69.10 |
| P₂O₅ Recovery % | 94.1 | | | |

Example 4 used the same laboratory apparatus and procedure as described in example 1. After silica removal the mill feed consisted of 25 kg at a grade of 10.1% P₂O₅, 2.75% Fe₂O₃, 7.22% Al₂O₃ and 56.2% SiO₂ with 47.2% of the mass being Ultrafines (−20 μm). The mill feed was ground to 98.6% −150 μm then conditioned at 75% solids using 22.2 gram of sodium carbonate, 1388 ml of fatty acid soap and 694 ml of 1 wt % guar gum solution. The slurry was diluted to 20% solids and then transferred to the Jameson Cell where flotation was carried out. Table 4 shows that 85.2% P₂O₅ was recovered to a concentrate grading 34.3% P₂O₅ while the Fe₂O₃ and Al₂O₃ grades were reduced to 2.05% and 0.94% respectively.

TABLE 4
Example 4 Flotation Results

| | P₂O₅ % | Fe₂O₃ % | Al₂O₃ % | SiO₂ % |
|---|---|---|---|---|
| Feed | 10.10 | 2.75 | 7.22 | 56.20 |
| Rougher | 29.70 | 2.83 | 1.75 | 14.40 |
| Concentrate | | | | |
| Final Concentrate | 34.30 | 2.05 | 0.94 | 6.10 |
| Final Tail | 1.95 | 2.17 | 9.99 | 75.20 |
| P₂O₅ Recovery % | 85.2 | | | |

### Example 5

Example 5 is from the operation of a 1 tonne per hour continuous pilot plant. In this process, after silica removal at 25 mm, the −25 mm material was fed to a rod mill and was ground to approximately 55% passing 150 micron. The mill discharge flowed to a hydrocyclone which split the slurry into an overflow which was 80% passing 150 micron and a course underflow that was recycled back to the mill for regrinding. The overflow was dewatered to approximately 70% solids and pumped to the conditioning tank where 0.8 kg/t sodium carbonate as a 10 wt % solution and 1.3 kg/t of fatty acid soap (5 wt % tall oil fatty acid, 5 wt % diesel and 0.25 wt % caustic soda) were added to the slurry and conditioned at 1000 rpm for approximately 10 minutes. The slurry was then diluted with softened site water to 25% solids and pumped to the Jameson Cell JC500 rougher feed box at 4.5 m³/h for rougher and scavenger flotation. Table 5 shows results from one day of operation using the same ore as was used for Examples 1-4. It can be seen that 86.4% P₂O₅ was recovered to a concentrate grading 32.2% P₂O₅ while the Fe₂O₃ and Al₂O₃ grades were reduced to 3.53% and 1.37% respectively.

TABLE 5
Example 5 Flotation Results

| | P₂O₅ % | Fe₂O₃ % | Al₂O₃ % | SiO₂ % |
|---|---|---|---|---|
| Feed | 18.9 | 4.65 | 3.28 | 41.7 |
| Final Concentrate | 32.2 | 3.53 | 1.37 | 11.8 |
| Final Tail | 5.22 | 5.72 | 4.89 | 73.0 |
| P₂O₅ Recovery % | 86.4 | | | |

### Examples 6 and 7

Examples 6 and 7 describe the processing of a phosphate bearing RC chip sample and a PQ diamond core sample taken from the field approximately 120 km north-west of Mt Isa in Queensland, Australia, as opposed to the bulk excavated samples that were used in Examples 1 to 5. The test work was completed using the same laboratory pilot scale apparatus as examples 1 to 4.

Example 6 describes the processing of a very low grade sample of only 6.46% P₂O₅. Most phosphate operations would consider the grade of this material too low to process using established methods. After silica removal at 25 mm, the mill feed consisted of 31 kg at 6.46% P₂O₅, 0.92% Fe₂O₃, 5.34% Al₂O₃ and 75.1% SiO₂ with 36% of the mass being Ultrafines (−20 μm). The mill feed was ground to 80% −150 μm, then it was conditioned at 75% solids for two minutes with 23.4 gram of sodium carbonate, followed by six minutes with 1460 ml of fatty acid soap (5 wt % tall oil fatty acid, 5 wt % diesel and 0.25 wt % caustic soda), followed by two minutes with 730 ml of 1 wt % guar gum solution. The conditioned slurry was then transferred to a dilution tank where softened water was added to lower the pulp density to approximately 20% solids, followed by flotation in the Jameson Cell. The results in Table 6 show that 91.2% P₂O₅ was recovered to a concentrate grading 34.7% P₂O₅, whilst the Fe₂O₃ and Al₂O₃ grades were 1.17% and 2.23% respectively.

TABLE 6
Example 6 Flotation Results

| | P₂O₅ % | Fe₂O₃ % | Al₂O₃ % | SiO₂ % |
|---|---|---|---|---|
| Feed | 6.46 | 0.92 | 5.34 | 75.10 |
| Rougher | 29.2 | 1.57 | 4.34 | 20.50 |
| Concentrate | | | | |
| Final Concentrate | 34.7 | 1.17 | 2.23 | 9.13 |
| Final Tail | 1.15 | 0.97 | 9.72 | 82.1 |
| P₂O₅ Recovery % | 91.2 | | | |

In Example 7, after silica removal at 25mm, the mill feed consisted of 61.7 kg at 16.20% P₂O₅, 5.35% Fe₂O₃, 7.01% Al₂O₃ and 38.4% SiO₂ with 41.3% of the mass being Ultrafines (−20 μm). The mill feed was ground to 93.7% −150 μm, then it was conditioned at 75% solids for two minutes with 46.6 gram of sodium carbonate, followed by six minutes with 2906 ml of fatty acid soap (5 wt % tall oil fatty acid, 5 wt % diesel and 0.25 wt % caustic soda), followed by two minutes with 1453 ml of 1 wt % guar gum solution. The conditioned slurry was then transferred to a dilution tank where softened water was added to lower the pulp density to approximately 20% solids, followed by flotation in the Jameson Cell. The results in Table 7 show that 94.1% P₂O₅ was recovered to a concentrate grading 33% P₂O₅, whilst the Fe₂O₃ and Al₂O₃ grades were reduced to 3.33% and 1.14% respectively.

TABLE 7
Example 6 Flotation Results

| | P₂O₅ % | Fe₂O₃ % | Al₂O₃ % | SiO₂ % |
|---|---|---|---|---|
| Feed | 16.20 | 5.35 | 7.01 | 38.40 |
| Rougher | 30.60 | 3.84 | 1.93 | 9.00 |
| Concentrate | | | | |
| Final Concentrate | 33.00 | 3.33 | 1.14 | 6.30 |
| Final Tail | 1.77 | 5.67 | 12.30 | 69.10 |
| P₂O₅ Recovery % | 94.10 | | | |

1. A method of beneficiation of phosphate from a phosphate ore comprising:
providing an aqueous slurry of phosphate ore in particulate form for conditioning comprising at least 60% by weight solids;
conditioning the aqueous slurry by contacting the aqueous slurry with at least one conditioning agent selected from fatty acids and salts thereof and at least one hydrocarbon;
diluting the conditioned slurry to provide a solids content of no more than 35% by weight;
subjecting the diluted slurry to froth flotation comprising combining a pressurized stream of diluted slurry with air in a downcomer to form a foam comprising a dispersed air phase and introducing a downward stream of the foam into a flotation chamber comprising liquid below a surface of the liquid to form a floated froth; and
collecting the floated froth to provide a solid enriched in phosphate.

2. A method according to claim 1 wherein the aqueous slurry of phosphate ore in particulate form for conditioning comprises in the range of from 65% to 85% solids.

3. A method according to claim 1 wherein the diluting of the conditioned slurry provides a solids content in the range of from 15% to 30% by weight.

4. A method according to claim 1 wherein the diluting of the conditioned slurry provides a solids content in the range of from 20% to 30% by weight.

5. A method according to claim 1 wherein the aqueous slurry subjected to conditioning comprises at least 20% by weight of particles of size less than 20 microns.

6. A method according to claim 1 wherein the aqueous slurry subjected to conditioning includes at least 30% by weight of particles less than 20 microns.

7. A method according to claim 1 wherein the aqueous slurry subjected to conditioning includes at least 40% by weight particles less than 20 microns.

8. A method according to claim 1 wherein the water is recycled from the flotation process and the recycled water is subject to deionization to reduce the combined magnesium ion and calcium ion content of the recycled water from more than 15 mg/L to no more than 10 mg/L.

9. A method according to claim 8 wherein the combination of magnesium ion and calcium ion content is reduced from more than 10 mg/L to no more than 5 mg/L.

10. A method according to claim 1 wherein the aqueous slurry is formed by milling the ore, forming a dilute aqueous slurry of the milled ore suitable for hydrocyclone classification and classifying the dilute aqueous slurry of the milled ore to provide a size fraction in which at least 80% by weight pass a 150 micron sieve; and reducing the water content of the slurry to provide said aqueous slurry for conditioning.

11. A method according to claim 10 wherein the solids content of the ore slurry for hydrocyclone classification is no more than 55% by weight.

12. A method according to claim 10 wherein the water content of the ore slurry is reduced by filtration.

13. A method according to claim 10 wherein the water content of the ore slurry is reduced by filtration using a belt filter.

14. A method according to claim 1 wherein the conditioned slurry has a pH in the range of from 9.0 to 10.0.

15. A method according to claim 8 wherein the conditioned slurry comprises sodium carbonate added to adjust the pH.

16. A method according to claim 15 wherein sodium carbonate is mixed with the aqueous slurry and subsequently the slurry is mixed with the conditioning agent and hydrocarbon.

17. A method according to claim 1 wherein the conditioning of the aqueous slurry is conducted with stirring of the aqueous slurry.

18. A method according to claim 1 wherein the conditioning further comprises contacting the aqueous slurry with a gum.

19. A method according to claim 18 wherein the gum is guar gum.

20. A method according to claim 18 wherein the gum is added in an amount of from 1% to 30% by weight based on the weight of collector agent.
